(19) United States
(12) Patent Application Publication
(10) Pub. No.: US 2023/0313549 A1
(43) Pub. Date: Oct. 5, 2023

(54) GUIDING SYSTEMS AND METHODS FOR AUTOMATIC SWIMMING POOL CLEANER

(71) Applicant: Zodiac Pool Care Europe, Belberaud (FR)

(72) Inventors: Arnaud Lancry, Le Vernet (FR); Louis Favié, Colomiers (FR)

(73) Assignee: Zodiac Pool Care Europe, Belberaud (FR)

(21) Appl. No.: 18/125,913

(22) Filed: Mar. 24, 2023

Related U.S. Application Data
(60) Provisional application No. 63/324,989, filed on Mar. 29, 2022.

(51) Int. Cl. E04H 4/16

(52) U.S. Cl. CPC E04H 4/1654

(57) ABSTRACT

A guiding system for a swimming pool provides external stimuli defining a path that is detectable by an automatic swimming pool cleaner. The path extends both vertically and horizontally in the swimming pool or spa. In some cases, the external stimuli define a transit path for the APC in a swimming pool or spa.

### REFERENCE TO RELATED APPLICATION

This application claims the benefit of U.S. Provisional Patent Application No. 63/324,989, filed on Mar. 29, 2022, and entitled GUIDING SYSTEMS AND METHODS FOR AUTOMATIC SWIMMING POOL CLEANER, the content of which is incorporated by reference in its entirety.

### FIELD OF THE INVENTION

The invention relates to systems and apparatuses for cleaning water-containing vessels such as swimming pools and spas and more particularly, although not necessarily exclusively, to automatic swimming pool cleaners (APCs).

### BACKGROUND OF THE INVENTION

Numerous cleaning devices capable of autonomous movement within swimming pools and spas currently exist. The most common of these devices are APCs, which often are either hydraulic or robotic in type. Hydraulic cleaners vary water flow for movement, while robotic cleaners typically employ electric motors to cause motion. Hydraulic APCs, furthermore, subdivide into “pressure-side” and “suction-side” cleaners, with pressure-side cleaners being fluidly connected to outputs of pumps of pool water circulation systems and suction-side cleaners being fluidly connected to inputs of such pumps.

APCs may utilize various algorithms to ensure probabilistic cleaning coverage of a pool surface. An APC following a random algorithm may clean a majority of a pool's surface after considerable time by cleaning in a straight line, turning to a random direction after encountering a barrier, and cleaning in a new straight line. An APC may follow a spiral algorithm, cleaning in expanding concentric circles until an obstacle is encountered, prompting a new spiral cleaning path. An APC may be equipped with sensors that may allow it to navigate a perimeter of a pool surface. Navigating a perimeter may allow an APC to construct a representation of the surface within a memory. However, establishing the representation by navigating the perimeter can be a time consuming, error prone process.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a guiding system provides an external stimuli defining a transit path of an APC.

According to various embodiments, a predefined path extends in a horizontal direction and a vertical direction within a pool, and the predetermined path is detectable by an APC and is defined by a guiding system external to the APC.

According to some embodiments, a wire path is disposed beneath a pool surface and is configured to provide an APC with a path for cleaning the pool surface.

According to some embodiments, at least one beacon is located within, on top of, or beneath a pool surface and is configured to provide an APC with a path for cleaning the pool surface.

According to certain embodiments, at least one beacon is located with, on top of, or beneath a pool surface and is configured to inform an APC of the APC's present location on a pool surface.

According to various embodiments, a wire path is disposed beneath a pool surface and is configured to facilitate reception and transmission of instructions and data between an APC and an entity located remotely from the APC.

According to some embodiments, an APC may dean a pod surface by any combination of following a wire path, receiving instructions form a wire path, following beacons, receiving instructions from beacons, using sensors within the APC itself, and/or using instructions within the APC itself.

According to various embodiments, an APC may avoid obstacles by any combination of following a wire path, receiving instructions form a wire path, following beacons, receiving instructions from beacons, using sensors within the APC itself, and/or using instructions within the APC itself.

According to certain embodiments, a pool system includes a guiding system defining a predefined path extending in a horizontal direction and a vertical direction within a swimming pool or spa, and an APC. The predefined path is detectable by the APC.

According to some embodiments, an APC includes means for detecting a predefined path extending in a horizontal direction and a vertical direction within a swimming pool or spa and generating an output based on the detection of the predefined path.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWING

FIG. 1 illustrates a guiding system for an APC according to embodiments.

### DESCRIPTION OF THE INVENTION

Described herein are guiding systems and methods for guiding an APC through an effective cleaning path of a pool surface by providing external stimuli or guides to the APC. The guiding systems and methods provided herein may allow for the APC to follow a path to make a full and rational coverage of the pool, which may allow the APC to reduce a cleaning cycle time to a minimum possible cycle time and/or ensure a more complete cleaning process. The guides of the guiding system may provide various external stimuli to the APC. The APC may sense the guides to follow a path defined by the guides. Following the path of guides beneath the pool surface may ensure a faster or more complete cleaning process than a process depending on a procedural algorithm or an internal map generated by an APC. In some embodiments, the guiding systems may communicate with the APC (e.g., transmitting data to and/or receiving data from the APC) and/or may facilitate communication between the APC and a device remote from the swimming pool or spa. Various other benefits and advantages may be realized with the systems and methods described herein, and the aforementioned benefits and advantages should not be considered limiting.

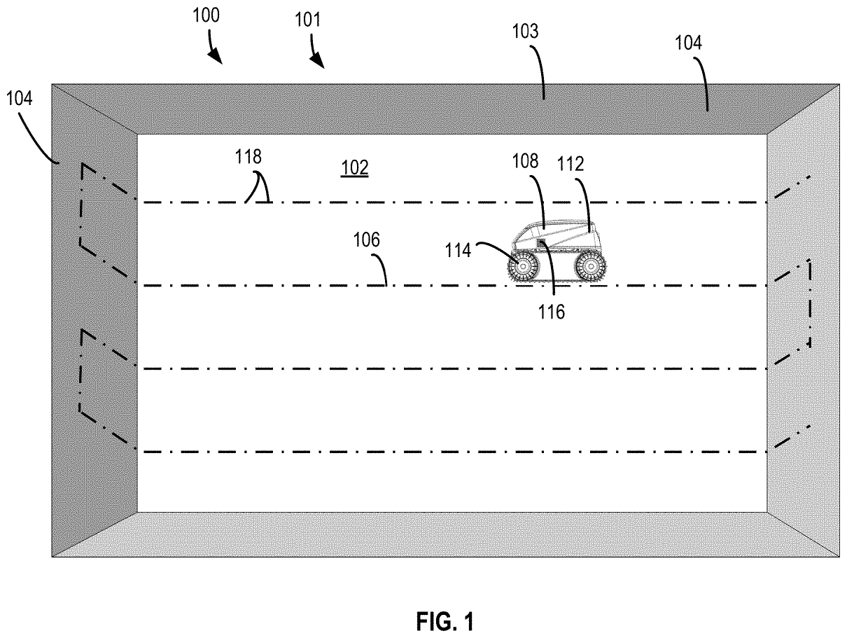

FIG. 1 illustrates an example of a pool system 100 with a guiding system 101 for an APC 108 according to embodiments.

The pool system 100 includes a swimming pool or spa 103 that may include one or more floor surface(s) 102 and one or more side wall surface(s) 104. In some embodiments, the floor surface 102 may extend horizontally, and the side wall surfaces 104 may extend vertically. The particular shape, size, and/or profile of the swimming pool or spa 103 illustrated in FIG. 1 should not be considered limiting, and in other embodiments swimming pools or spas with other shapes, profiles, and/or sizes may be utilized.

As illustrated in FIG. 1, the guiding system 101 defines a path 106 that traverses the floor surface 102 and side wall surfaces 104 of the swimming pool or spa 103 such that the path 106 extends vertically and horizontally. The particular path 106 illustrated in FIG. 1 should not be considered limiting as in other embodiments, paths with other shapes or profiles may be defined by the guiding system 101.

The path 106 may be defined by one or more beacons or guides 118 that provide external stimuli for defining the path 106. In some embodiments, a single or continuous guide 118 may define the path 106, while in other embodiments, a plurality of guides 118 may define the path 106. As a non-limiting example, a first guide 118 may define the portion of the path 106 on the floor surface 102 and a second guide 118 may define the portion of the path 106 on the side wall surface 104. Moreover, within the swimming pool or spa 100, the guiding system 101 may have a a single, connected path 106 or multiple, unconnected paths 106.

In some embodiments, at least some of the guide(s) 118 may be provided on the surface(s) of the swimming pool or spa 103. Additionally, or alternatively, at least some of the guide(s) 118 may be embedded within and/or beneath the surface(s) of the swimming pool or spa 103. In some embodiments, the guide(s) 118 of the guiding system 118 are associated with the swimming pool or spa 103 itself, such as underneath the liner or other surface of the swimming pool or spa 103, and are external to the APC 108.

The guides 118 of the guiding system 101 may be various types of guides 118 for providing external stimuli for defining the path 106 as desired. As non-limiting examples, the guides 118 may include wires providing an electric field and/or magnetic field as the external stimuli, wireless beacons providing wireless signals as the external stimuli, optical beacons providing light signals and/or other visual information as the external stimuli, magnetic beacons for providing magnetic fields as the external stimuli, acoustic beacons for providing sound signals as the external stimuli, combinations thereof, and/or other types of guides 118 as desired. As mentioned, the guides 118 may be arranged on and/or within the pool surfaces such that they are detectable by the APC 108. As non-limiting examples, the wire as the guide 118 may be provided within or on the pool surfaces, magnets as guides 118 may be provided within or on the pool surfaces, light sources as guides 118 maybe be provided on the pool surfaces, patterns may be printed on the pool surfaces as guides 118, etc.

In some embodiments, the guiding system 101 may include more than one type of guide 118. As a non-limiting example, the guiding system may utilize an electrical wire as a first type of guide 118 and a magnetic beacon as a second type of guide 118. Various other combinations of guides 118 may be utilized as desired.

In the embodiment illustrated in FIG. 1, a single guide 118 is utilized, and the guide 118 is a wire. In such embodiments, prior to completion of the surfaces 102, 104 of the swimming pool or spa 100, the wire may be arranged in a desired shape of the path 106 beneath what will become the pool surface. The wire path may be constructed beneath the pool surfaces 102, 104 to traverse a variety of surfaces. For example, the wire may be arranged beneath the pool surface so that the path 106 extends along both the floor and walls of the swimming pool or spa 100.

The APC 108 generally includes a body 110, one or more motive elements 112, and one or more cleaning devices (including but not limited to a scrubber brush). A motor, pump, filter, and various other features may be provided on or within the APC 108 as desired. Non-limiting examples of APCs 108 may include those described in U.S. Pat. Nos. 10,316,534, 9,488,154, 8,578,538, and U.S. Patent Publication No. 2014/0303810, all of which are hereby incorporated by reference in their entireties.

The APC 108 includes one or more sensors 116 or other suitable means for detecting the external stimuli of the guides 118. As non-limiting examples, the sensors 116 may include electrical sensors (e.g., for sensing current, electrical field, voltage, etc.), magnetic sensors such as but not limited to magnetometers (e.g., for sensing magnetic fields, etc.), light-based sensors, optical sensors, sound sensors, acoustic sensors, wireless communication sensors (e.g., radio frequency, Bluetooth, NFC, etc.), combinations thereof, and/or other sensors or combinations of sensors as desired.

The APC 108 may generate various outputs and/or perform various actions based on the detection of the path 106.

In certain embodiments, the APC 108 may use the one or more sensors 116 to identify and follow the path 106 of the guiding system 101. In such embodiments, the external stimuli from the guides 118 of the guiding system 101 define a transit path 106 for the APC 108. As a non-limiting example, the APC 108 may use a voltage sensor as the sensor 116 to identify and follow the path 106 of wire as the guide 118 along both the floor and walls of the swimming pool or spa 100. In certain embodiments, the APC 108 may perform a cleaning cycle based on the detection and following of the path 106. Following the path 106 may ensure a faster or more complete cleaning process compared to a process based on a procedural algorithm or an internal map generated by an APC. In some embodiments, the APC 106 may follow the path 106 to avoid obstacles, such as stairs or sunken obstacles.

Additionally, or alternatively, the APC 108 may transmit data to and/or receive data from the guides 118 defining the path 106. As a non-limiting example, the APC 108 may receive instructions from the external stimuli, such as but not limited to an instruction to return to a surface, and/or the APC 108 may transmit operational information, such as but not limited to battery life or refuse canister capacity, through the path 106.

Additionally, or alternatively, the APC 108 may transmit data to and/or receive data from a remote device using the path 106. As an example, the APC 108 may communicate with a remote application on a pool owner's device using the path 106 by transmitting and/or receiving operational data about the APC 108 to the path 106, which is in turn communicated to the repot device using various wired and/or wireless communication protocols as desired.

Optionally, the guides 118 may passively provide information to the APC 108. As a non-limiting example, a particular guide 118 may include a unique identifier corresponding to a particular location in the swimming pool or spa 100, and the APC 108 sensing the guide 118 for guiding purposes may also use the guide 118 to determine its position within the swimming pool or spa 100. Other types of information may be actively or passively provided to the APC using the guides 118 as desired.

In other embodiments, the APC 108 may direct itself using any combination of internal instructions (such as a random algorithm), instructions to follow the path 106, instructions relevant to the guides 108, and/or instructions received from the path 106, among others.

Exemplary concepts or combinations of features of the invention may include:
A. A guiding system providing an external stimuli defining a transit path of an APC.
B. A pool comprising the guiding system of any preceding or subsequent statement or combination of statements.
C. An APC comprising sensing means for detecting the external stimuli provided by the guiding system of any preceding or subsequent statement or combination of statements.
D. The guiding system of any preceding or subsequent statement or combination of statements comprising a plurality of guides providing the external stimuli, wherein the plurality of guides comprises at least one of:
   a. a plurality of wire paths;
   b. a plurality of magnetic sources;
   c. a plurality of light sources;
   d. a plurality of printed patterns; or
   e. a plurality of wireless beacons.
E. The guiding system according to any preceding or subsequent statement or combination of statements, wherein the transit path is defined in a horizontal direction and a vertical direction.
F. A predefined path extending in a horizontal direction and a vertical direction within a pool, the predetermined path detectable by an APC and defined by a guiding system external to the APC.
G. A wire path, disposed beneath a pool surface, configured to provide an APC with a path for cleaning the pool surface.
H. At least one beacon, located within, on top of, or beneath a pool surface, configured to provide an APC with a path for cleaning the pool surface.
I. The at least one beacon of statement H, where the at least one beacon is external to the APC.
J. At least one beacon, located with, on top of, or beneath a pool surface, configured to inform an APC of the APC's present location on a pool surface.
K. A wire path, disposed beneath a pool surface, configured to facilitate reception and transmission of instructions and data between an APC and an entity located remotely from the APC.
L. An APC configured to clean a pool surface by any combination of following a wire path, receiving instructions form a wire path, following beacons, receiving instructions from beacons, using sensors within the APC itself, or using instructions within the APC itself.
M. An APC configured to avoid obstacles by any combination of following a wire path, receiving instructions form a wire path, following beacons, receiving instructions from beacons, using sensors within the APC itself, or using instructions within the APC itself.
N. A guiding system providing an external stimuli defining a transit path for APC in a swimming pool or spa.
O. The guiding system of any preceding or subsequent statement or combination of statements, wherein the guiding system comprises a plurality of guides providing the external stimuli.
P. The guiding system of any preceding or subsequent statement or combination of statements, wherein at least one guide of the plurality of guides is beneath a pool surface of the swimming pool or spa.
Q. The guiding system of any preceding or subsequent statement or combination of statements, wherein the plurality of guides comprise at least one of:
   a. a plurality of wire paths;
   b. a plurality of magnetic sources;
   c. a plurality of light sources;
   d. a plurality of printed patterns; or
   e. a plurality of wireless beacons.

R. The guiding system of any preceding or subsequent statement or combination of statements, wherein the transit path is defined in a horizontal direction and a vertical direction.

S. A pool comprising the guiding system of any preceding or subsequent statement or combination of statements.

T. A pool system comprising the guiding system of any preceding or subsequent statement or combination of statements and an APC, wherein the APC comprises sensing means for detecting the external stimuli provided by the guiding system.

U. A pool system comprising:
a. a guiding system defining a predefined path extending in a horizontal direction and
   a vertical direction within a swimming pool or spa; and
b. an APC, wherein the predefined path is detectable by the APC.

V. The pool system of any preceding or subsequent statement or combination of statements, wherein the predefined path is defined by one or more guides, and wherein the one or more guides are beneath a pool surface of the swimming pool or spa.

W. The pool system of any preceding or subsequent statement or combination of statements, wherein the one or more guides comprise at least one of:
a. one or more wire paths;
b. one or more magnetic sources;
c. one or more light sources;
d. one or more printed patterns; or
e. one or more wireless beacons.

X. The pool system of any preceding or subsequent statement or combination of statements, wherein the APC is configured to clean a surface of the swimming pool or spa by following the predefined path.
Y. The pool system of any preceding or subsequent statement or combination of statements, wherein the APC is configured to determine a location of the APC within the swimming pool or spa based on the predefined path.
Z. The pool system of any preceding or subsequent statement or combination of statements, wherein the APC is configured to transmit data to and/or receive data from the predefined path.
AA. The pool system of any preceding or subsequent statement or combination of statements, wherein the APC is configured to communicate with a device external to the swimming pool or spa using the predefined path.
BB. An APC comprising means for detecting a predefined path extending in a horizontal direction and a vertical direction within a swimming pool or spa and generating an output based on the detection of the predefined path.
CC. The APC of any preceding or subsequent statement or combination of statements, wherein the APC is configured to clean the swimming pool or spa by following the predefined path as the output.
DD. The APC of any preceding or subsequent statement or combination of statements, wherein the APC is configured to transmit data to and/or receive data from the predefined path as the output.
EE. The APC of any preceding or subsequent statement or combination of statements, wherein the APC is configured to transmit data to and/or receive data from a device external to the swimming pool or spa using the predefined path as the output.
FF. The APC of any preceding or subsequent statement or combination of statements, wherein the APC is configured to identify a location of the APC within the swimming pool or spa based on the predefined path as the output.
GG. The APC of any preceding or subsequent statement or combination of statements, wherein the means for detecting the predefined path comprise one or more of:
   a. an electrical sensor;
   b. a magnetic sensor;
   c. a light sensor;
   d. an optical sensor; or
   e. a wireless communication sensor.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with APCs, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

That which is claimed:

1. A guiding system providing an external stimuli defining a transit path for an automatic swimming pool cleaner (APC) in a swimming pool or spa.

2. The guiding system of claim 1, wherein the guiding system comprises a plurality of guides providing the external stimuli.

3. The guiding system of claim 2, wherein at least one guide of the plurality of guides is beneath a pool surface of the swimming pool or spa.

4. The guiding system of claim 2, wherein the plurality of guides comprise at least one of:
a. a plurality of wire paths;
b. a plurality of magnetic sources;
c. a plurality of light sources;
d. a plurality of printed patterns; or
e. a plurality of wireless beacons.

5. The guiding system of claim 1, wherein the transit path is defined in a horizontal direction and a vertical direction.

6. A pool comprising the guiding system of claim 1.

7. A pool system comprising the guiding system of claim 1 and an APC, wherein the APC comprises sensing means for detecting the external stimuli provided by the guiding system.

8. A pool system comprising:
a. a guiding system defining a predefined path extending in a horizontal direction and a vertical direction within a swimming pool or spa; and
b. an automatic swimming pool cleaner (APC), wherein the predefined path is detectable by the APC.

9. The pool system of claim 8, wherein the predefined path is defined by one or more guides, and wherein the one or more guides are beneath a pool surface of the swimming pool or spa.

10. The pool system of claim 9, wherein the one or more guides comprise at least one of:
a. one or more wire paths;
b. one or more magnetic sources;
c. one or more light sources;
d. one or more printed patterns; or
e. one or more wireless beacons.

11. The pool system of claim 7, wherein the APC is configured to clean a surface of the swimming pool or spa by following the predefined path.

12. The pool system of claim 7, wherein the APC is configured to determine a location of the APC within the swimming pool or spa based on the predefined path.

13. The pool system of claim 7, wherein the APC is configured to transmit data to and/or receive data from the predefined path.

14. The pool system of claim 7, wherein the APC is configured to communicate with a device external to the swimming pool or spa using the predefined path.

15. An automatic swimming pool cleaner (APC) comprising means for detecting a predefined path extending in a horizontal direction and a vertical direction within a swimming pool or spa and generating an output based on the detection of the predefined path.

16. The APC of claim 15, wherein the APC is configured to clean the swimming pool or spa by following the predefined path as the output.

17. The APC of claim 15, wherein the APC is configured to transmit data to and/or receive data from the predefined path as the output.

18. The APC of claim 15, wherein the APC is configured to transmit data to and/or receive data from a device external to the swimming pool or spa using the predefined path as the output.

19. The APC of claim 15, wherein the APC is configured to identify a location of the APC within the swimming pool or spa based on the predefined path as the output.

20. The APC of claim 15, wherein the means for detecting the predefined path comprise one or more of:
a. an electrical sensor;
b. a magnetic sensor;
c. a light sensor;
d. an optical sensor; or
e. a wireless communication sensor.
